(19) United States
(12) Patent Application Publication
(10) Pub. No.: US 2008/0194210 A1
(43) Pub. Date: Aug. 14, 2008

(54) Radio Frequency Transceiver Devices, Systems, Methods and Computer Program Products for Controlling Quiescent-Mode Power Consumption

(75) Inventors: Tadd C. Torborg, Raleigh, NC (US); Stephen S. Jackson, Chapel Hill, NC (US)

Correspondence Address: MYERS BIGEL SIBLEY & SAJOVEC, PO BOX 37428, RALEIGH, NC, 27627, US

(73) Assignee: RadarFind Corporation

(21) Appl. No.: 12/028,945

(22) Filed: Feb. 11, 2008

Related U.S. Application Data
(60) Provisional application No. 60/900,880, filed on Feb. 12, 2007.
(60) Provisional application No. 60/900,881, filed on Feb. 12, 2007.
(60) Provisional application No. 60/900,811, filed on Feb. 12, 2007.

(51) Int. Cl. H04B 1/38

(52) U.S. Cl. 455/73

(57) ABSTRACT

Radio frequency transceiver devices configured to communicate with a plurality of peer devices within a defined proximity of the radio frequency transceiver devices are provided. The radio frequency transceiver device includes a transceiver configured to transmit instructions to a subset of the plurality of peer devices within the defined proximity of the radio frequency transceiver device. The transmitted instructions indicate to the subset of the plurality of peer devices that the plurality of peer devices should alter at least one data process in the subset of the plurality of peer devices. Related systems, methods and computer program products are also provided.

### CLAIM OF PRIORITY

This application claims priority to U.S. Provisional Application No. 60/900,880, filed on Feb. 12, 2007 entitled Methods, Systems and Devices For Controlling Quiescent-Mode Power Consumption; U.S. Provisional Application No. 60/900,881, filed on Feb. 12, 2007, entitled Methods, Systems, Devices And Computer Program Products For Radio Wave Diversity, And Pattern Measurement And Heuristically Adaptive Spread Spectrum Multiplexing; and U.S. Provisional Application No. 60/900,811 filed on Feb. 12, 2007, entitled Methods, Systems, Devices and Computer Program Products for Hierarchical Distribution of Adaptive Time Synchronization, Processing Mutltiparametric Data and Administering Distributed Time Correlative Data, the contents of which are incorporated herein by reference as if set forth in their entirety.

### FIELD OF THE INVENTION

This invention relates to asset management and, more particularly, to automated control of internal power source usage and related devices, systems methods and computer program products.

### BACKGROUND OF THE INVENTION

Asset management is becoming a major concern for companies, hospitals, schools, libraries and the like. In other words, as these institutions become larger, it is becoming increasingly difficult to manage the location of assets or resources, for example, high-value, mobile assets or resources of which there is a limited quantity available, such as defibrillators. Thus, when one of the many patients in the hospital needs a defibrillator, it is important that the hospital personnel be able to locate a defibrillator for the patient and ascertain its status, for example, in use, available, broken and the like, in a timely manner. Asset management issues may also arise in institutions other than hospitals. For example, a large company may employ far more people than it has portable computers. Thus, when one of the employees needs a portable computer for a business trip, it is important that the employee be able to locate a portable computer and ascertain its status. However, as these institutions become larger, it may become increasingly difficult to monitor the location and status of these high-value, mobile resources. Inefficient asset can lead to over allocation of funds to purchase more of the limited resources than necessary.

Currently, asset management may include manual asset searches, i.e., send a person to locate the asset, the use of bar codes affixed to the asset management or the use of legacy radio frequency tags. However, each of these methods has drawbacks. For example, sending a person to locate an available device may be overly time consuming as well as unsuccessful. Affixing a barcode to the device may not provide any status information, may also be time consuming, unsuccessful and expensive. Legacy radio frequency tags may not provide any device status information, may not be designed for a particular institution's environment, may be expensive and disruptive to install.

A company by the name of Radianse, Inc., of Lawrence, Mass. has attempted to provide a more practical solution to asset management in a hospital environment. Radianse provides indoor positioning solutions (IPS) for healthcare institutions. In particular, Radianse IPSs use long-range active radio frequency identification (RFID) location technology for location and association of people, places and things. Information is shared using web and interface standards such as extensible markup language (XML) and short message service (SMS), and Radianse receivers directly connect to a hospital's existing local area network (LAN).

In particular, to track assets with a Radianse IPS, small, battery-powered transmitters (tags) are attached to mobile medical devices. The tags continuously transmit active RFID information and infrared signals to Radianse receivers plugged into a hospital's existing LAN. The Radianse receivers are standalone devices that are installed in various places in the hospital environment. The RFID information may be received by multiple receivers within a certain perimeter of the tag, but the infrared signal may only be received by the receivers in the same room as the tag due to the nature of infrared. Web-based location software analyzes and displays on a computer screen the exact location based on the RFID information and the infrared signal in real time. Data may also be stored for transfer to any standards-based clinical or hospital information system.

Since the Radianse tag continuously transmits to a reader, the battery life of the tag may only be from about a year to about 16 months, thus, tag replacement may be time consuming and costly. Furthermore, the use of infrared signals to pinpoint the exact location of the mobile medical device may be unreliable as anything placed between the tag and the receiver may block the receiver from receiving the infrared signal. Finally, the Radianse receivers are standalone devices that require installation and integration with the hospital system, which may be burdensome and costly. Accordingly, improved methods of asset management may be desired.

Tags are also discussed in U.S. Pat. Nos. 5,686,902 and 6,765,484, the disclosures of which are hereby incorporated herein by reference as if set forth in its entirety.

### SUMMARY OF THE INVENTION

Some embodiments of the present invention provide radio frequency transceiver devices configured to communicate with a plurality of peer devices within a defined proximity of the radio frequency transceiver devices. The radio frequency transceiver device includes a transceiver configured to transmit instructions to a subset of the plurality of peer devices within the defined proximity of the radio frequency transceiver device. The transmitted instructions indicate to the subset of the plurality of peer devices that the plurality of peer devices should alter at least one data process in the subset of the plurality of peer devices.

In further embodiments of the present invention, the subset of the plurality of peer devices may include all of the plurality of peer devices within the defined proximity, less than all of plurality of peer devices within the defined proximity or a single one of the plurality of peer devices within the defined proximity.

In still further embodiments of the present invention, the transmitted instructions may include at least one timed and coded radio frequency message. The at least one timed and coded radio frequency message may be controlled by special properties of the radio frequency transceiver device such that the timed and coded message is only received at the subset of the plurality of peer devices within the defined proximity. A range of the defined proximity may be proportional to output power. The timed and coded message may include at least a synchronization message, a status message including a status of the subset of the plurality of peer devices and a physical device identification number associated with the radio frequency transceiver device. In certain embodiments, the status may include quiet, active or wait.

In some embodiments of the present invention, the device may further include a housing, a power source, a processor and an antenna. The power source may be positioned within the housing and the processor may be configured to communicate with the transceiver and the power source. The antenna may be associated with the transceiver and configured to transmit the instructions to the subset of the plurality of peer devices. The processor may be configured to monitor a status of the power source. The processor may be configured to determine if the status of the power source has reached or exceeded a predetermined threshold and automatically perform a predetermined action if it is determined that the predetermined threshold has been reached. The predetermined action may include removing power from the radio frequency transceiver device and/or transmitting a request for help from the radio frequency transceiver device.

In further embodiments of the present invention, the transceiver may be further configured to receive a command message indicating a content of the instructions to be transmitted to the subset of the plurality of peer devices. The command message may include at least a synchronization message, a command message including the instructions and a logical identification number identifying the subset of the plurality of peer devices. A processor may be further configured to associate the logical identification number identifying the subset of the plurality of peer devices with actual physical identification numbers of each of the plurality of peer devices in the subset. The command message may be addressed to the subset of the plurality of peer devices.

In still further embodiments of the present invention, the transmitted instructions may further include instructions to alter the at least one data process by accelerating, decelerating, incrementing, decrementing, ceasing or beginning the at least one data process in the subset of the plurality of peer devices within the defined proximity. The transmitted instructions may instruct the subset of the plurality of peer devices to enter quiescent mode for a fixed period of time. The device may have a distinctive appearance so as to allow identification of the device among the plurality of peer devices.

In some embodiments of the present invention, the device may be available in a plurality of colors, each of the colors indicating a different fixed period of time.

While described above primarily with reference to radio frequency transceiver devices, it will be understood that the present invention further includes related methods, systems and computer program products.

### BRIEF DESCRIPTION OF THE DRAWINGS

FIG. 1 is a block diagram illustrating a shipping box including a radio frequency transceiver device (“slug tag”) according to some embodiments of the present invention.

FIG. 2 is a block diagram illustrating a radio frequency transceiver device according to some embodiments of the present invention.

FIG. 3 is a system including a radio frequency transceiver device, a plurality of peer tags and a computing device according to some embodiments of the present invention.

FIG. 4 is a block diagram of a data processing system suitable for use in devices according to some embodiments of the present invention.

FIGS. 5 through 8 are flowcharts illustrating operations according to various embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Example embodiments are described below with reference to block diagrams and/or flowchart illustrations of methods, devices, systems and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, example embodiments may be implemented in hardware and/or in software (including firmware, resident software, micro-code, etc.). Furthermore, example embodiments may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of example embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

As discussed above, improved methods of asset management may be desired. For example, improved methods of asset management are discussed in commonly assigned U.S. patent application Ser. No. 11/108,262, filed Apr. 18, 2005 to Jackson entitled Methods, Location Circuits and Computer Program Products for Automated Location and Monitoring of Mobile Devices; U.S. patent application Ser. No. 11/108,307, filed Apr. 18, 2005 to Jackson entitled Methods, Systems and Computer Program Products for Automated Location and Monitoring of Mobile Devices; and U.S. patent application Ser. No. 11/108,324, filed Apr. 18, 2005 to Jackson entitled Methods, Identification Tags and Computer Program Products for Automated Location and Monitoring of Mobile Devices, the disclosures of which are hereby incorporated herein by reference as if set forth in its entirety. As discussed therein, a plurality of identification circuits, for example, tags, may be associated with corresponding mobile devices. The identification circuits may be configured to listen for a request for presence information from location circuits, when the identification circuits are awake. If the identification circuits are awake and hear a request from a location circuit(s), the identification circuits may respond to the request for presence information. The responses may be used to determine relative proximity of the mobile devices associated with the identification circuits as discussed in detail in U.S. patent application Ser. Nos. 11/108,262, 11/108,307 and 11/108,324, the disclosures of which have been incorporated herein by reference above.

As used herein, “presence information” may specifically refer to a response indicating the presence of a mobile device within a certain perimeter (proximity) of a location circuit according to some embodiments of the present invention. As further used herein, a “mobile device” refers to a device or resource capable of being moved from one place to another. In some embodiments of the present invention, the mobile device may be a high value mobile asset, such as a defibrillator or a laptop computer. However, it will be understood that mobile devices according to some embodiments of the present invention may include library books, files and other lesser value resources without departing from the scope of the present invention.

As discussed in U.S. patent application Ser. Nos. 11/108,262, 11/108,307 and 11/108,324, in some embodiments, the identification circuits may include an internal power source, for example, a battery. To conserve battery life, the identification circuit (tag) may be in a sleep mode most of the time and may only wake up periodically to listen for the request from the identification circuit. However, in a situation where the tags are not being used, for example, while the tags are being shipped, even waking tip periodically may waste battery power.

Thus, according to some embodiments of the present invention, special-purpose devices that are intended to be packaged with other hardware elements, for example, tags (identification circuits) of the same system are provided. In particular, in some embodiments of the present invention a radio frequency transceiver device may be configured to act as a “slug,” which may deactivate peer elements in close proximity to the device while the peer elements are in quiescent modes of operations, such as might be encountered in warehouse storage, shipping, ready-inventory, and the like. Some embodiments of the present invention will be discussed herein where the radio frequency transceiver device is referred to as a “slug tag” and the peer elements are referred to as “peer tags” having batteries internal thereto. However, it will be understood that embodiments of the present invention are not limited to tags. For example, any device having an internal power source and its peer elements may be used in accordance with some embodiments of the present invention without departing from the scope of the present invention.

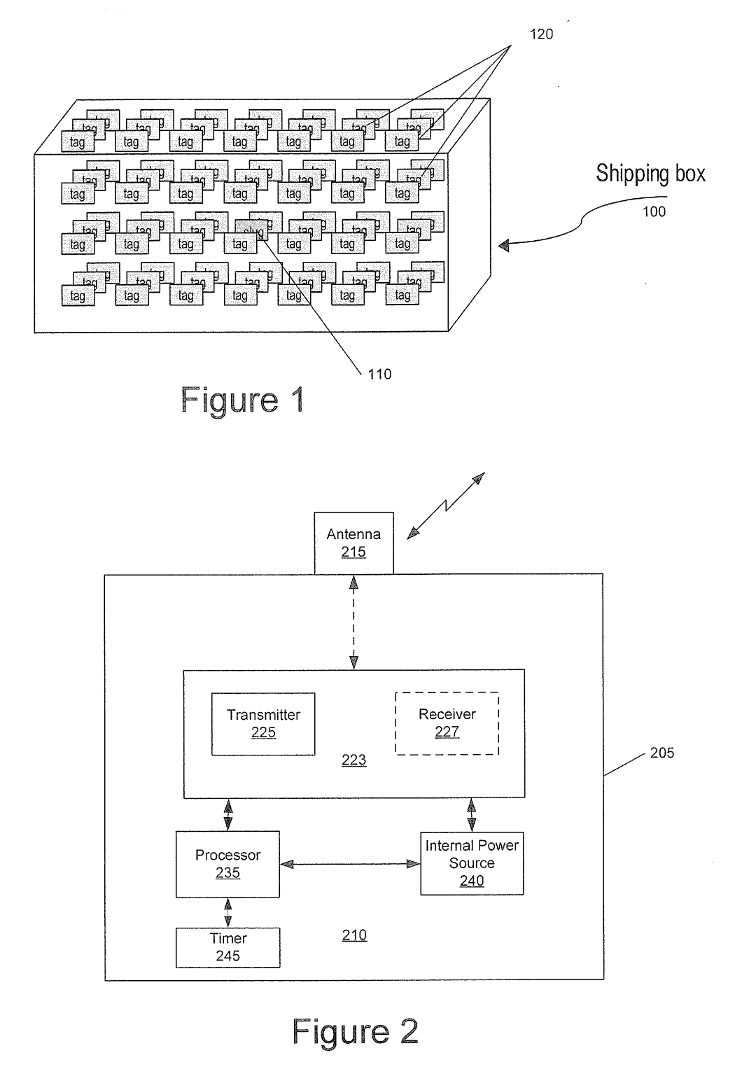

In some embodiments, the “slug tag” may be configured to transmit a relatively low level signal containing basic instructions to the peer tags to enable desired characteristics of the peer tags, for example, low battery power drain, no transmission, and the like. Methods, systems and devices for controlling quiescent-mode power consumption according to some embodiments of the present invention will be discussed further herein with respect to FIGS. 1 through 8.

As discussed above, when tags including an internal power source are shipped or stored in a warehouse it may be advantageous to deactivate tags for a period of time. Thus, according to some embodiments of the present invention, a radio frequency transceiver device (slug tag) may be provided in a shipping box or storage container with the peer tags. The slug tag may be configured to transmit instructions to the peer tags within a defined proximity, for example, within about 2.0 to about 150 feet, of the slug tag. FIG. 1 illustrates a slug tag 110 being packaged with a plurality of peer tags 120 in a shipping box 100 in accordance with some embodiments of the present invention. The instructions transmitted to the plurality of peer tags 120 from the slug tag 110 may indicate to the plurality of peer tags 120 that the plurality of peer tags 120 should alter at least one data process in the plurality of peer tags 120.

In particular, the slug tag 110 may be configured to send instructions to the plurality of peer tags 120 within a defined proximity of the slug tag 110 instructing the peer tags 120 to go to sleep for twenty-four hours. Accordingly, the peer tags 120 will not wake up and listen for a full day. This period of time may change based on whether the tags are being shipped or stored and the like. For example, tags intended to be stored in a warehouse may be instructed to go to sleep for 2 months or more without departing from the scope of the present invention. Thus, it will be understood that the time periods provided herein are examples only and embodiments of the present invention are not limited thereby.

In some embodiments of the present invention, once the slug tag 110 instructs the peer tags 120 to go to sleep for the indicated period of time, the peer tags 120 will not wake up until the indicated period of time has elapsed. Once the peer tags 120 wake up again, the peer tags 120 may receive further instructions from the slug tag 110 to go back to sleep for a period of time or may begin normal operation as discussed in U.S. patent application Ser. Nos. 11/108,262, 11/108,307 and 11/108,324, the disclosures of which were incorporated by reference above. In other words, once the slug tag 110 is removed from the defined proximity of the peer tags 120, the peer tags 120 may be resume normal operation. The slug tag 110 may be discarded once the peer tags 120 have reached their destination. In some embodiments of the present invention, the slug tag 110 may be returned to the shipping entity for reuse.

In some embodiments of the present invention, the slug tag 110 may have a distinctive appearance from the peer tags 120 so as to allow identification of the slug tag 110 among the plurality of peer tags 120. This may be important, as the peer tags 120 may not resume normal operation until the slug tag 110 is removed from the proximity of the peer tags 120. Furthermore, in some embodiments of the present invention, the slug tags 110 may be provided in a plurality of colors. Each color slug tag 110 may be configured to instruct the peer devices 120 to go to sleep for a different period of time. For example, a yellow slug tag 110 may instruct the peer tags 120 to go to sleep for 24 hours and a blue slug tag 110 may instruct the peer tags 120 to go to sleep for 1 month and so on. Although some embodiments of the present invention have been discussed with respect to pre-programmed slug tags 110, embodiments of the present invention are not limited to this configuration. In particular, slug tags 110 according to some embodiments of the present invention may receive instructions in real time and provide those instructions to the peer tags 120 as will be discussed further herein. Furthermore, although the shipping box 100 is illustrated as only including a single slug tag 110, embodiments of the present invention are not limited to this configuration. Two or more slug tags 110 may be provided in the shipping box 100 without departing from the scope of the present invention.

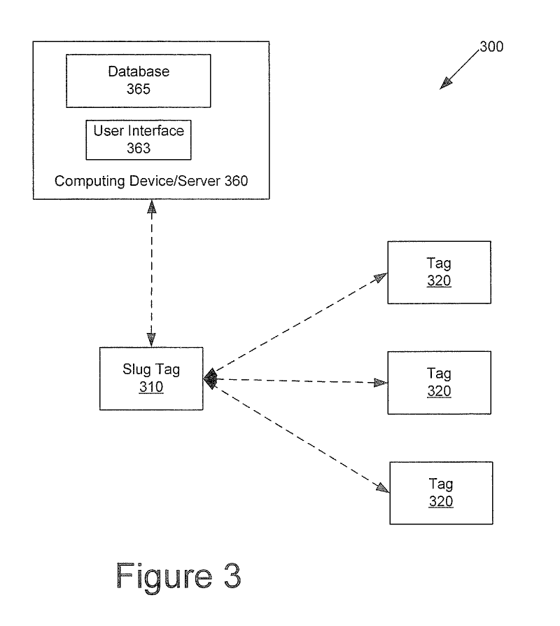

Referring now to FIG. 2, a block diagram of a radio frequency transceiver device according to some embodiments of the present invention will be discussed. As illustrated in FIG. 2, a radio frequency transceiver device 210 according to some embodiments of the present invention includes a housing 205, an antenna 215, transceiver 223, a processor 235, an internal power source 240 and a timer 245. Dotted lines indicate optional elements. A discussed above, a radio frequency transceiver device (slug tag) 210 is configured to communicate with a plurality of peer devices within a defined proximity of the radio frequency transceiver device 210. The transmitter 225 of the transceiver 223 is configured to transmit instructions to a subset of the plurality of peer devices within the defined proximity of the radio frequency transmitter device 210 using the antenna 215. The subset of the plurality of peer devices may be all of the plurality of peer devices within the defined proximity, less than all of plurality of peer devices within the defined proximity or a single one of the plurality of peer devices within the defined proximity. The defined proximity may be from about 2.0 to about 150 ft. In some embodiments of the present invention, the range of the radio frequency transmitter device 210 may be changed by increasing/decreasing the output power. The peer devices may be selected using a logical identification number, addresses and/or physical identification numbers without departing from the scope of the present invention.

The transmitted instructions may indicate to the subset of the plurality of peer devices that the plurality of peer devices should alter at least one data process in the subset of the plurality of peer devices. For example, the instructions may instruct the subset of the plurality of peer devices to go to sleep for 24 hours. In some embodiments of the present invention, the transmitted instructions may be one or more timed and coded radio frequency messages. The one or more timed and coded radio frequency message may be controlled by special properties of the radio frequency transceiver device 210 such that the timed and coded messages are only received at the subset of the plurality of peer devices within the defined proximity. In some embodiments of the present invention, the special properties of the radio frequency transmitter device 210 may be related to the type of antenna 215, the connection to the antenna 215 and/or the power setting of the transceiver 223.

In some embodiments of the present invention, the timed and coded message may include at least a synchronization message, a status message including a status of the subset of the plurality of peer devices and a physical device identification number associated with the radio frequency transmitter device. The status may be, for example, quiet, active or wait.

In some embodiments of the present invention, the processor 235 may be configured to monitor a status of the power source 240 of the radio frequency transceiver device 210. The processor 235 may be further configured to determine if the status of the power source has reached or exceeded a predetermined threshold. For example, the predetermined threshold may be that the internal power source 240 of the radio frequency transceiver device 210 only has five minutes of power remaining. If it is determined that the threshold has been met or exceeded, the processor 235 may be configured to automatically perform a predetermined action. The predetermined action may be removing power from the radio frequency transmitter device 210 and/or transmitting a request for help from the radio frequency transmitter device 210. Any predetermined action may be performed without departing from the scope of the present invention.

As discussed above, in some embodiments of the present invention, the radio frequency transmitter device 210 may be configured to receive at receiver 227 a command message indicating a content of the instructions to be transmitted to the subset of the plurality of peer devices. Thus, instead of being preprogrammed with the time intervals to send to the peer tags, radio frequency transmitter devices may receive command messages including variable instructions therein. In some embodiments of the present invention, the command message may include at least a synchronization message, a command message including the instructions and a logical identification number identifying the subset of the plurality of peer devices. A logical identification number may identify, for example, all tags within a 150 meter range of the radio frequency transmitter device 210.

The processor 235 may be further configured to associate the logical identification number identifying the subset of the plurality of peer devices with actual physical identification numbers of each of the plurality of peer devices in the subset. In some embodiments of the present invention, the command message may be addressed to the subset of the plurality of peer devices. For example, all peer tags having an address range of from X to Y.

In some embodiments of the present invention, the transmitted instructions may further include instructions to alter the at least one data process by accelerating, decelerating, incrementing, decrementing, ceasing or beginning the at least one data process in the subset of the plurality of peer devices within the defined proximity. The transmitted instructions may instruct the subset of the plurality of peer devices to enter quiescent mode for a fixed period of time as discussed above.

Thus, according to some embodiments of the present invention, methods of selecting and establishing quiescent mode(s) of peer elements may be provided. In further embodiments of the present invention methods of intercommunications amongst peer devices and exemplary embodiments may be provided. In still further embodiments of the present invention, methods of powering of the device and enabling and disabling modes and packaging of the device may also be provided.

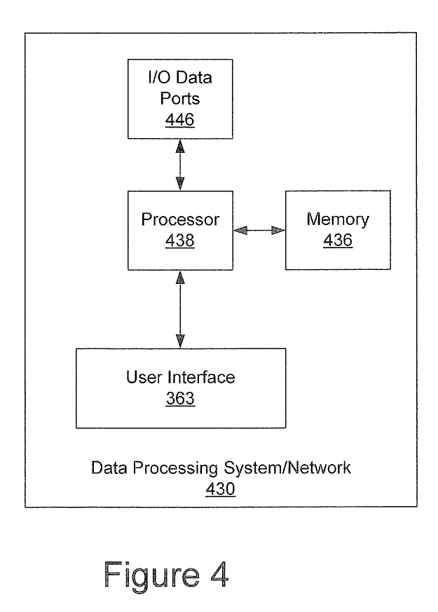

Referring now to FIG. 3, a system according to some embodiments of the present invention will be discussed. As illustrated in FIG. 3, the system 300 includes a slug tag 310,a plurality of peer tags 320 and computing device 360. Although only a single slug tag and three peer tags are illustrated in FIG. 3, it will be understood that embodiments of the present invention are not limited to this configuration. For example, more than one slug tag and less than three or more than three peer tags can be provided in the system 300 without departing from the scope of the present invention. As discussed above, the slug tag 310 may be configured to provide instructions to the peer tags 320. For example, the slug tag 310 may be configured to instruct the peer tags 320 to go to sleep for 2 hours. As discussed above, the slug tags 310 may be preprogrammed or the instructions may be provided to the slug tag 310 by the computing device 360. As further illustrated, the computing device 360 may include a user interface 363 and database 365 configured with instructions for the peer devices 320.

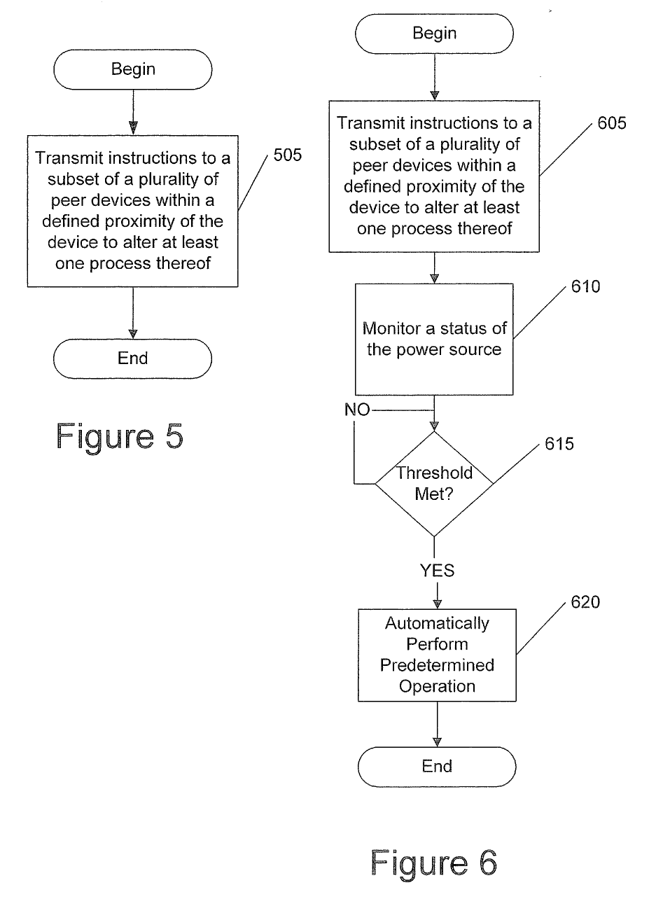

FIG. 4 illustrates an exemplary embodiment of a data processing system 430, which may be included in devices, for example, computing device 360, in accordance with some embodiments of the present invention. The data processing system 430 may include a user interface 363, including, for example, input device(s) such as a keyboard or keypad, a display, a speaker and/or microphone, and a memory 436 that communicate with a processor 438. The data processing system 430 may further include an I/O data port(s) 446 that also communicates with the processor 438. The I/O data ports 446 can be used to transfer information between the data processing system 430 and another computer system, device or a network using, for example, an Internet Protocol (IP) connection or wireless connection. These components may be conventional components such as those used in many conventional data processing systems, which may be configured to operate as described herein.

The processor 438 can be any commercially available or custom enterprise, application, personal, pervasive and/or embedded microprocessor, microcontroller, digital signal processor or the like. The memory 436 may include any memory devices containing the software and data used to implement the functionality of the data processing system 430. The memory 436 can include, but is not limited to, the following types of devices: ROM, PROM, EPROM, EEPROM, flash memory, SRAM, and DRAM.

Furthermore, the memory 436 may include several categories of software and data used in the system, for example, an operating system; application programs; input/output (I/O) device drivers; and data. As will be appreciated by those of skill in the art, the operating system may be any operating system suitable for use with a data processing system, such as OS/2, AIX or zOS from International Business Machines Corporation, Armonk, N.Y., Windows95, Windows98, Windows2000 or WindowsXP, or Windows CE from Microsoft Corporation, Redmond, Wash., Palm OS, Symbian OS, Cisco TOS, VxWorks, Unix or Linux. The I/O device drivers typically include software routines accessed through the operating system by the application programs to communicate with devices such as the I/O data port(s) 446 and certain memory 436 components. The application programs are illustrative of the programs that implement the various features of the system and preferably include at least one application that supports operations according to embodiments of the present invention. Finally, the data may represent the static and dynamic data used by the application programs, the operating system, the I/O device drivers, and other software programs that may reside in the memory 436.

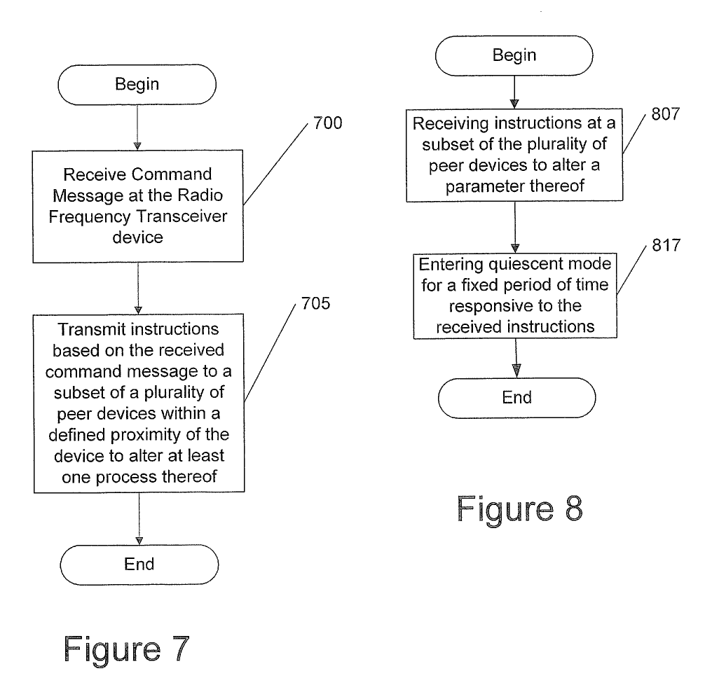

Operations according to various embodiments of the present invention will now be further described with reference to the flowchart illustrations of FIGS. 5 through 8. Referring first to FIG. 5, methods for controlling data processes in a plurality of peer devices within a defined proximity of a radio frequency transceiver device will be discussed. Operations begin at block 505 by transmitting instructions to a subset of the plurality of peer devices within the defined proximity of the radio frequency transceiver device. The transmitted instructions indicate to the subset of the plurality of peer devices that the plurality of peer devices should alter at least one data process in the subset of the plurality of peer devices.

Referring now to FIG. 6, operations begin at block 605 by transmitting instructions to a subset of the plurality of peer devices within the defined proximity of the radio frequency transceiver device. The transmitted instructions indicate to the subset of the plurality of peer devices that the plurality of peer devices should alter at least one data process in the subset of the plurality of peer devices. In some embodiments of the present invention, the subset of the plurality of peer devices comprises all of the plurality of peer devices within the defined proximity, less than all of plurality of peer devices within the defined proximity or a single one of the plurality of peer devices within the defined proximity. The instructions may instruct the subset of the plurality of peer devices to enter quiescent mode for a fixed period of time.

A status of an internal power source of the radio frequency transceiver device may be monitored (block 610). It is determined if the status of the power source has reached or exceeded a predetermined threshold (block 615). If it is determined that the threshold has been reached or exceeded (block 615), a predetermined action may be automatically performed (block 620). The predetermined action may include removing power from the radio frequency transceiver device and/or transmitting a request for help from the radio frequency transceiver device. If it is determined that the threshold has not been reached (block 615), operations remain at block 615 until the threshold is met or the radio frequency transceiver device is removed from the defined proximity of the peer devices.

Referring now to FIG. 7, operations begin at block 700 by receiving a command message indicating a content of the instructions to be transmitted to the subset of the plurality of peer devices. Instructions may be transmitted to a subset of the plurality of peer devices within the defined proximity of the radio frequency transceiver device based on the received command message (block 705).

Referring now to FIG. 8, methods for controlling data processes in a plurality of peer devices within a defined proximity of a radio frequency transceiver device will be discussed. Operations begin at block 807 by receiving instructions at a subset of the plurality of peer devices within the defined proximity of the radio frequency transceiver device. The transmitted instructions indicate to the subset of the plurality of peer devices that the plurality of peer devices should alter at least one data process in the subset of the plurality of peer devices. A quiescent mode may be entered at the subset of the plurality of peer devices for a fixed period of time responsive to the received instructions (block 817).

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A radio frequency transceiver device configured to communicate with a plurality of peer devices within a defined proximity of the radio frequency transceiver device, the radio frequency transceiver device comprising:
a transceiver configured to transmit instructions to a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

2. The device of claim 1, wherein the subset of the plurality of peer devices comprises all of the plurality of peer devices within the defined proximity, less than all of plurality of peer devices within the defined proximity or a single one of the plurality of peer devices within the defined proximity.

3. The device of claim 1, wherein the transmitted instructions comprise at least one timed and coded radio frequency message.

4. The device of claim 3, wherein at least one timed and coded radio frequency message is controlled by special properties of the radio frequency transceiver device such that the timed and coded message is only received at the subset of the plurality of peer devices within the defined proximity.

5. The device of claim 4, wherein a range of the defined proximity is proportional to output power.

6. The device of claim 3, wherein the timed and coded message comprises at least a synchronization message, a status message including a status of the subset of the plurality of peer devices and a physical device identification number associated with the radio frequency transceiver device.

7. The device of claim 6, wherein the status comprises quiet, active or wait.

8. The device of claim 1, wherein the device further comprises:
a housing;
a power source within the housing;
a processor configured to communicate with the transceiver and the power source; and
an antenna associated with the transceiver and configured to transmit the instructions to the subset of the plurality of peer devices.

9. The device of claim 8, wherein the processor is configured to monitor a status of the power source.

10. The device of claim 9, wherein the processor is further configured to:
determine if the status of the power source has reached or exceeded a predetermined threshold and automatically perform a predetermined action if it is determined that the predetermined threshold has been reached.

11. The device of claim 10, wherein the predetermined action comprises removing power from the radio frequency transceiver device and/or transmitting a request for help from the radio frequency transceiver device.

12. The device of claim 1, wherein the transceiver is further configured to receive a command message indicating a content of the instructions to be transmitted to the subset of the plurality of peer devices.

13. The device of claim 12, wherein the command message comprises at least a synchronization message, a command message including the instructions and a logical identification number identifying the subset of the plurality of peer devices.

14. The device of claim 13, wherein the radio frequency transceiver device further comprises a processor that is configured to associate the logical identification number identifying the subset of the plurality of peer devices with actual physical identification numbers of each of the plurality of peer devices in the subset.

15. The device of claim 12, wherein the command message is addressed to the subset of the plurality of peer devices.

16. The device of claim 1, wherein the transmitted instructions further comprise instructions to alter the at least one data process by accelerating, decelerating, incrementing, decrementing, ceasing or beginning the at least one data process in the subset of the plurality of peer devices within the defined proximity.

17. The device of claim 16, wherein the transmitted instructions instruct the subset of the plurality of peer devices to enter quiescent mode for a fixed period of time.

18. The device of claim 17, wherein the device has a distinctive appearance so as to allow identification of the device among the plurality of peer devices.

19. The device of claim 1, wherein the device is available in a plurality of colors, each of the colors indicating a different fixed period of time.

20. A system for controlling data processes of peer devices with a defined proximity of a radio frequency transceiver device, comprising:
a plurality of peer devices; and
a radio frequency transceiver device configured to transmit instructions to a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

21. The system of claim 1, wherein the subset of the plurality of peer devices comprises all of the plurality of peer devices within the defined proximity, less than all of plurality of peer devices within the defined proximity or a single one of the plurality of peer devices within the defined proximity.

22. The system of claim 20, wherein the transmitted instructions comprise at least one timed and coded radio frequency message.

23. The system of claim 22, wherein the timed and coded message comprises at least a synchronization message, a status message including a status of the subset of the plurality of peer devices and a physical device identification number associated with the radio frequency transceiver device.

24. The system of claim 20, wherein the radio frequency transceiver device is further configured to receive a command message indicating a content of the instructions to be transmitted to the subset of the plurality of peer devices.

25. The system of claim 24, wherein the timed and coded message comprises at least a synchronization message, a command message including the instructions and a logical identification number identifying the subset of the plurality of peer devices.

26. The system of claim 20, wherein the transmitted instructions instruct the subset of the plurality of peer devices to enter quiescent mode for a fixed period of time.

27. A method for controlling data processes in a plurality of peer devices within a defined proximity of a radio frequency transceiver device, the method comprising:
transmitting instructions to a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

28. The method of claim 27, wherein the subset of the plurality of peer devices comprises all of the plurality of peer devices within the defined proximity, less than all of plurality of peer devices within the defined proximity or a single one of the plurality of peer devices within the defined proximity.

29. The method of claim 27, wherein transmitting instructions further comprises transmitting instructions that instruct the subset of the plurality of peer devices to enter quiescent mode for a fixed period of time.

30. The method of claim 27, further comprising monitoring a status of the power source.

31. The method of claim 30 further comprising:
determining if the status of the power source has reached or exceeded a predetermined threshold; and
automatically performing a predetermined action if it is determined that the predetermined threshold has been reached.

32. The method of claim 31, wherein automatically performing the predetermined action comprises removing power from the radio frequency transceiver device and/or transmitting a request for help from the radio frequency transceiver device.

33. The method of claim 27, further comprising receiving a command message indicating a content of the instructions to be transmitted to the subset of the plurality of peer devices.

34. A method for controlling data processes in a plurality of peer devices within a defined proximity of a radio frequency transceiver device, the method comprising:
receiving instructions at a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

35. The method of claim 34, further comprising entering quiescent mode for a fixed period of time responsive to the received instructions.

36. A computer program product for controlling data processes in a plurality of peer devices within a defined proximity of a radio frequency transceiver device, the computer program product comprising:
a computer readable medium having computer readable program code embodied therein, the computer readable medium comprising:
computer readable program code configured to transmit instructions to a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

37. The computer program product of claim 36, wherein the subset of the plurality of peer devices comprises all of the plurality of peer devices within the defined proximity, less than all of plurality of peer devices within the defined proximity or a single one of the plurality of peer devices within the defined proximity.

38. The computer program product of claim 36, wherein the computer readable program code configured to transmit instructions further comprises computer readable program code configured to transmit instructions that instruct the subset of the plurality of peer devices to enter quiescent mode for a fixed period of time.

39. The computer program product of claim 36, further comprising computer readable program code configured to monitor a status of the power source.

40. The computer program product of claim 39 further comprising:
computer readable program code configured to determine if the status of the power source has reached or exceeded a predetermined threshold; and
automatically performing a predetermined action if it is determined that the predetermined threshold has been reached.

41. The computer program product of claim 40, wherein the computer readable program code configured to automatically perform the predetermined action comprises computer readable program code configured to remove power from the radio frequency transceiver device and/or computer readable program code configured to transmit a request for help from the radio frequency transceiver device.

42. The computer program product of claim 36, further comprising computer readable program code configured to receive a command message indicating a content of the instructions to be transmitted to the subset of the plurality of peer devices.

43. A computer program product for controlling data processes in a plurality of peer devices within a defined proximity of a radio frequency transceiver device, the computer program product comprising:
a computer readable medium having computer readable program code embodied therein, the computer readable medium comprising:
computer readable program code configured to receive instructions at a subset of the plurality of peer devices within the defined proximity of the radio frequency transceiver device, the transmitted instructions indicating to the subset of the plurality of peer devices that the plurality of peer devices should alter at least one data process in the subset of the plurality of peer devices.

44. The computer program product of claim 43, further comprising computer readable program code configured enter quiescent mode for a fixed period of time responsive to the received instructions.
